(19) United States
(12) Patent Application Publication
(10) Pub. No.: US 2021/0201893 A1
(43) Pub. Date: Jul. 1, 2021

(54) PATTERN-BASED ADAPTATION MODEL FOR DETECTING CONTACT INFORMATION REQUESTS IN A VEHICLE

(71) Applicant: Beijing DiDi Infinity Technology and Development Co., Ltd., Beijing (CN)

(72) Inventors: Ying Lyu, Santa Clara, CA (US); Kun Han, Sunnyvale, CA (US)

(21) Appl. No.: 17/135,338

(22) Filed: Dec. 28, 2020

Related U.S. Application Data
(60) Provisional application No. 62/955,872, filed on Dec. 31, 2019.

(51) Int. Cl. G10L 15/08; G10L 15/26; G10L 25/63; G10L 15/22

(52) U.S. Cl. CPC G10L 15/08; G10L 15/22; G10L 25/63; G10L 15/26

(57) ABSTRACT

Certain aspects disclosed herein improve on inappropriate behavior detection by applying machine-learning techniques to identify inappropriate behavior in real-time, or near real-time. For example, one or more patterns can be generated that represent possible incidences of inappropriate behavior, such as a request for a user's contact information. Audio segments captured by a wireless device in a vehicle can be converted into text using an automatic speech recognition system, and an adaptation model can apply the pattern(s) to the text to determine portions of the text that match at least one pattern and portions of the text that do not match any pattern, with the adaptation model labeling the text portions accordingly. The adaptation model can then pre-train a text classification model with the labeled text portions. The adaptation model obtains manually labeled data points and re-trains or updates the pre-trained text classification model using the manually labeled data points.

### INCORPORATION BY REFERENCE TO ANY PRIORITY APPLICATIONS

This application claims the benefit of priority under 35 U.S.C. § 119(e) of U.S. Provisional Patent Application No. 62/955,872, entitled “PATTERN-BASED ADAPTATION MODEL FOR DETECTING CONTACT INFORMATION REQUESTS IN A VEHICLE” and filed on Dec. 31, 2019, the disclosure of which is hereby incorporated by reference herein in its entirety. Any and all applications, if any, for which a foreign or domestic priority claim is identified in the Application Data Sheet of the present application are hereby incorporated by reference in their entireties under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

Vehicles—such as vehicles used for ride-sharing purposes, vehicles that provide driver-assist functionality, and/or automated or autonomous vehicles (AVs)—may obtain and process sensor data using an on-board data processing system to perform a variety of functions. For example, functions can include determining and/or displaying navigational routes, identifying road signs, detecting objects and/or road obstructions, controlling vehicle operation, and/or the like.

In some instances, a user of ride-sharing services may be mistreated by another user, such as a fellow rider or a driver. For example, a user may be verbally harassed, improperly propositioned, threatened, robbed, or treated in other illegal or undesirable ways. Reports submitted by victims or other users of improper behavior by drivers or fellow passengers can help identify users that behaved illegally or inappropriately, enabling disciplinary action to be performed. However, in some circumstances, awaiting a report to be submitted by a victim is insufficient. For example, in some cases, the delay in receiving the report may prevent or reduce the effectiveness of countermeasures that may be performed. Further, in some cases, a victim may not report an occurrence of harassment or other inappropriate or illegal behaviors.

### SUMMARY

One aspect of the disclosure provides a computer-implemented method as generally shown and described herein and equivalents thereof.

Another aspect of the disclosure provides a system as generally shown and described herein and equivalents thereof.

Another aspect of the disclosure provides a non-transitory computer readable medium storing instructions, which when executed by at least one computing device, perform a method as generally shown and described herein and equivalents thereof.

Another aspect of the disclosure provides a computer-implemented method for detecting a request for contact information in a vehicle. The computer-implemented method comprises: as implemented by an interactive computing system comprising one or more hardware processors and configured with specific computer-executable instructions, receiving an audio segment comprising a portion of audio captured by a microphone located within the vehicle; converting the audio segment to a text segment; providing at least the text segment to a trained text classification model to obtain an inappropriate behavior prediction; and determining that a user is being subjected to inappropriate behavior by another user in the vehicle based at least in part on the inappropriate behavior prediction.

The computer-implemented method of the preceding paragraph can include any sub-combination of the following features: where the computer-implemented method further comprises providing the audio segment to an emotion detector to obtain a detected emotion of a speaking user that made an utterance included in the audio segment, and determining based at least in part on the inappropriate behavior prediction and the detected emotion that a user is being subjected to inappropriate behavior by the another user; where the inappropriate behavior comprises a request for contact information of the user; and where the trained text classification model comprises one of a trained hierarchical attention network (HAN) or a trained convolutional neural network (CNN) model.

Another aspect of the disclosure provides a computer-implemented method for training a model to detect a request for contact information. The computer-implemented method comprises: as implemented by an interactive computing system comprising one or more hardware processors and configured with specific computer-executable instructions, receiving an audio segment comprising a portion of audio associated with a ride-share event; converting the audio segment to a text segment; obtaining one or more patterns associated with inappropriate behavior detection; determining that the text segment matches at least one of the one or more patterns; labeling the text segment as corresponding to inappropriate behavior; pre-training a text classification model using at least in part the labeled text segment; obtaining manually labeled data associated with inappropriate behavior detection; and training the pre-trained text classification model using at least in part the manually labeled data.

Another aspect of the disclosure provides a computer-implemented method for detecting a request for contact information in a vehicle. The computer-implemented method comprises: receiving an audio segment comprising a portion of audio captured by a microphone located within the vehicle; converting the audio segment to a text segment; providing at least the text segment to a trained text classification model to obtain an inappropriate behavior prediction; and determining that a user is being subjected to inappropriate behavior by another user in the vehicle based at least in part on the inappropriate behavior prediction.

The computer-implemented method of the preceding paragraph can include any sub-combination of the following features: where the computer-implemented method further comprises providing the audio segment to an emotion detector to obtain a detected emotion of a speaking user that made an utterance included in the audio segment, and determining based at least in part on the inappropriate behavior prediction and the detected emotion that a user is being subjected to inappropriate behavior by the another user; where the inappropriate behavior comprises a request for contact information of the user; where the trained text classification model comprises one of a trained hierarchical attention network (HAN) or a trained convolutional neural network (CNN) model; where the computer-implemented method further comprises: receiving a second audio segment comprising a portion of second audio associated with a ride-share event, converting the second audio segment to a second text segment, obtaining one or more patterns associated with inappropriate behavior detection, determining that the second text segment matches at least one of the one or more patterns, labeling the second text segment as corresponding to inappropriate behavior, pre-training a text classification model using at least in part the labeled second text segment, obtaining manually labeled data associated with inappropriate behavior detection, and training the pre-trained text classification model using at least in part the manually labeled data to form the trained text classification model; where the one or more patterns each comprise one or more rules that, if satisfied, indicate that inappropriate behavior has occurred; where the computer-implemented method further comprises filtering noise from the audio segment prior to converting the audio segment to the text segment; where filtering noise from the audio segment further comprises filtering, from the audio segment, at least one of a non-utterance, audio related to a navigation system, or audio uttered by a user other than a user present inside the vehicle; where filtering noise from the audio segment further comprises filtering, from the audio segment, audio associated with spoken directions based on a known output from a navigation application; where the computer-implemented method further comprises causing a countermeasure to be initiated in response to the determination that the user is being subjected to the inappropriate behavior by the another user; where a user device operated by a passenger in the vehicle comprises the microphone; and where a user device operated by a driver of the vehicle comprises the microphone.

Another aspect of the disclosure provides a system comprising a data store comprising a trained text classification model. The system further comprises a processor in communication with the data store, the processor configured with computer-executable instructions that, when executed, cause the processor to: obtain an audio segment comprising a portion of audio captured by a microphone located within a vehicle; convert the audio segment to a text segment from the data store; retrieve the trained text classification mode; provide at least the text segment to the trained text classification model to obtain an inappropriate behavior prediction; and determine that a user is being subjected to inappropriate behavior by another user in the vehicle based at least in part on the inappropriate behavior prediction.

The system of the preceding paragraph can include any sub-combination of the following features: where the computer-executable instructions, when executed, further cause the processor to: provide the audio segment to an emotion detector to obtain a detected emotion of a speaking user that made an utterance included in the audio segment, and determine based at least in part on the inappropriate behavior prediction and the detected emotion that a user is being subjected to inappropriate behavior by the another user; where the inappropriate behavior comprises a request for contact information of the user; where the trained text classification model comprises one of a trained hierarchical attention network (HAN) or a trained convolutional neural network (CNN) model; and where the computer-executable instructions, when executed, further cause the processor to: obtain a second audio segment comprising a portion of second audio associated with a ride-share event, convert the second audio segment to a second text segment, obtain one or more patterns associated with inappropriate behavior detection, determine that the second text segment matches at least one of the one or more patterns, label the second text segment as corresponding to inappropriate behavior, pre-train a text classification model using at least in part the labeled second text segment, obtain manually labeled data associated with inappropriate behavior detection, and train the pre-trained text classification model using at least in part the manually labeled data to form the trained text classification model.

Another aspect of the disclosure provides non-transitory, computer-readable storage media comprising computer executable instructions for detecting a request for contact information in a vehicle, where the computer-executable instructions, when executed by a computing system, cause the computing system to: obtain an audio segment comprising a portion of audio captured by a microphone located within the vehicle; convert the audio segment to a text segment from the data store; provide at least the text segment to a trained text classification model to obtain an inappropriate behavior prediction; and determine that a user is being subjected to inappropriate behavior by another user in the vehicle based at least in part on the inappropriate behavior prediction.

The non-transitory, computer-readable storage media of the preceding paragraph can include any sub-combination of the following features: where the computer-executable instructions, when executed, further cause the computing system to: provide the audio segment to an emotion detector to obtain a detected emotion of a speaking user that made an utterance included in the audio segment, and determine based at least in part on the inappropriate behavior prediction and the detected emotion that a user is being subjected to inappropriate behavior by the another user; and where the computer-executable instructions, when executed, further cause the computing system to: obtain a second audio segment comprising a portion of second audio associated with a ride-share event, convert the second audio segment to a second text segment, obtain one or more patterns associated with inappropriate behavior detection, determine that the second text segment matches at least one of the one or more patterns, label the second text segment as corresponding to inappropriate behavior, pre-train a text classification model using at least in part the labeled second text segment, obtain manually labeled data associated with inappropriate behavior detection, and train the pre-trained text classification model using at least in part the manually labeled data to form the trained text classification model.

### BRIEF DESCRIPTION OF THE DRAWINGS

FIG. 1A illustrates a block diagram of a networked vehicle environment in which one or more vehicles and/or one or more user devices interact with a server via a network, according to certain aspects of the present disclosure.

FIG. 1B illustrates a block diagram showing the vehicle of FIG. 1A in communication with one or more other vehicles and/or the server of FIG. 1A, according to certain aspects of the present disclosure.

FIG. 2 illustrates a block diagram showing additional and/or alternative details of the networked vehicle environment of FIG. 1A in accordance with certain aspects of the present disclosure.

FIG. 3 illustrates a block diagram of a safety incidence detection system in accordance with certain aspects of the present disclosure.

FIG. 4 illustrates a block diagram of the adaptation model of FIG. 3 in accordance with certain aspects of the present disclosure.

FIG. 5A presents a table of sample datasets applied to an embodiment of the safety incidence detection system.

FIG. 5B presents a table of example performance results as a result of an application of an embodiment of the safety incidence detection system and embodiments of other systems.

FIGS. 6 and 7 illustrate a set of graphs illustrating experimental results achieved as a result of an application of embodiments of other systems.

FIG. 8 illustrates a graph illustrating experimental results achieved as a result of an application of an embodiment of the safety incidence detection system.

FIG. 9 shows a flow diagram illustrative of embodiments of a routine implemented by the server to detect a request for contact information by a passenger or driver in a vehicle.

### DETAILED DESCRIPTION

As previously described, relying on users to report inappropriate behavior—such as a driver or passenger asking a user (e.g., a driver, a passenger, etc.) for the user's contact information—that may occur during a ride-sharing trip can be ineffective. For example, the reporting of inappropriate behavior may be delayed as reporting typically happens after the inappropriate behavior has concluded or the ride has completed. Often, the reporting may be significantly delayed as it takes some victims time to reach a mental state where the victims are capable of reporting the inappropriate behavior. Some users never reach a state where they feel comfortable enough to report inappropriate behavior and thus, some instances of inappropriate behavior are never reported. Accordingly, it is desirable to have a system that can identify inappropriate or other illicit behavior in real-time (e.g., within a few seconds of when the behavior occurred, with little or no perceptible delay to the user) or near real-time.

One solution to the problem of delayed or non-reporting of inappropriate behavior is to record audio using a wireless device, such as the wireless device executing the ride-sharing application (e.g., the wireless device of the driver, the wireless device of the passenger, etc.), and detecting inappropriate behavior by applying the recorded audio as an input to a supervised learning model. However, a challenge in supervised learning is obtaining labeled training data for training the supervised learning model. Training on a dataset with imbalanced classes will lead to poor performance. Empirically, for a safety detection binary classification problem like the one described herein, the best ratio of positive samples (e.g., orders of asking contact information) to negative samples (e.g., regular orders without intent of asking contact information) may be between 1:1 and 1:3. Given that inappropriate behavior usually happens infrequently (usually one order of inappropriate behavior among ten of thousands of orders, or a ratio of positives to negatives being 1:10,000), the labeling candidates could be obtained from the relevant historical user claims of inappropriate behavior rather than from an entire dataset (e.g., all of the orders in one day). This is because an order (e.g., a sample) that has been reported by users as an inappropriate behavior claim has a much higher probability (e.g., 1:10) of being a positive order of asking for contact information than any other type of order from the entire dataset. For the same volume of training data (e.g., 1000), to obtain a good ratio of positives to negatives (e.g., 1:3), it may be less time-consuming and less computationally expensive to manually label candidates on the user claims with a smaller number of orders (e.g., 250*10 or 2500 orders) than on the large-scale, entire dataset (e.g., 250*10,000 or 2.5 million orders), but the resulting performance of the trained learning model may be poor.

Alternatively, another solution to the problem of delayed or non-reporting of inappropriate behavior is to record in-car audio during a ride-share trip using a wireless device and to compare text derived from the audio to user-defined patterns to detect whether the audio (and therefore an order) includes speech associated with inappropriate behavior. Although useful in some cases, this solution may have some drawbacks in some instances. For example, the performance of the pattern matching is sometimes poor due to noisy data. Specifically, the patterns generally fail to take into account the context of what a user has uttered. As an illustrative example, the pattern matching may not differentiate between a driver asking a passenger for the passenger's social media information (which represents inappropriate behavior) and the driver telling the passenger that the passenger may have a better shopping experience if the passenger provides a salesperson with the passenger's social media information so that the salesperson can provide the passenger with photos any time new items arrive (which represents appropriate behavior). As another example, sometimes the captured audio has ambient noise (e.g., a voice from the navigation system, a voice broadcast over the radio or originating from recorded media, a voice that otherwise does not originate from a conversation between a driver and passenger(s), etc.) that makes pattern matching difficult. Further, it can be challenging and time-consuming to create the patterns that exactly match audio data (and therefore orders) with inappropriate behavior.

Certain aspects disclosed herein improve on inappropriate behavior detection without the aforementioned drawbacks by applying machine-learning techniques to identify inappropriate behavior in real-time, or near real-time (e.g., within seconds or less of receiving audio data). For example, one or more patterns can be generated that represent possible incidences of inappropriate behavior. Audio segments captured by a wireless device in a vehicle can be converted into text using an automatic speech recognition (ASR) system, and an adaptation model and/or a model generation system can apply the pattern(s) to the text to determine portions of the text that match at least one pattern and portions of the text that do not match any pattern, with the adaptation model and/or model generation system labeling the text portions accordingly. The adaptation model and/or model generation system can then pre-train a discriminative model or text classification model (e.g., a hierarchical attention network (HAN), a convolutional neural network (CNN), a machine learning model, a neural network, or any other type of artificial intelligence model) with the labeled text portions. Separately, the adaptation model and/or model generation system obtains a small number of manually labeled data points (e.g., on the order of hundreds of data points) that includes text portions identified as being inappropriate behavior and/or text portions identified as being appropriate behavior. The adaptation model and/or model generation system can then re-train or update the pre-trained discriminative model or text classification model using the manually labeled data points, which produces a trained discriminative model or text classification model that predicts instances of inappropriate behavior using, as an input, text converted from audio segments captured in a vehicle. In some cases, emotion detection may be combined with text analysis to determine the probability that an audio segment includes inappropriate behavior.

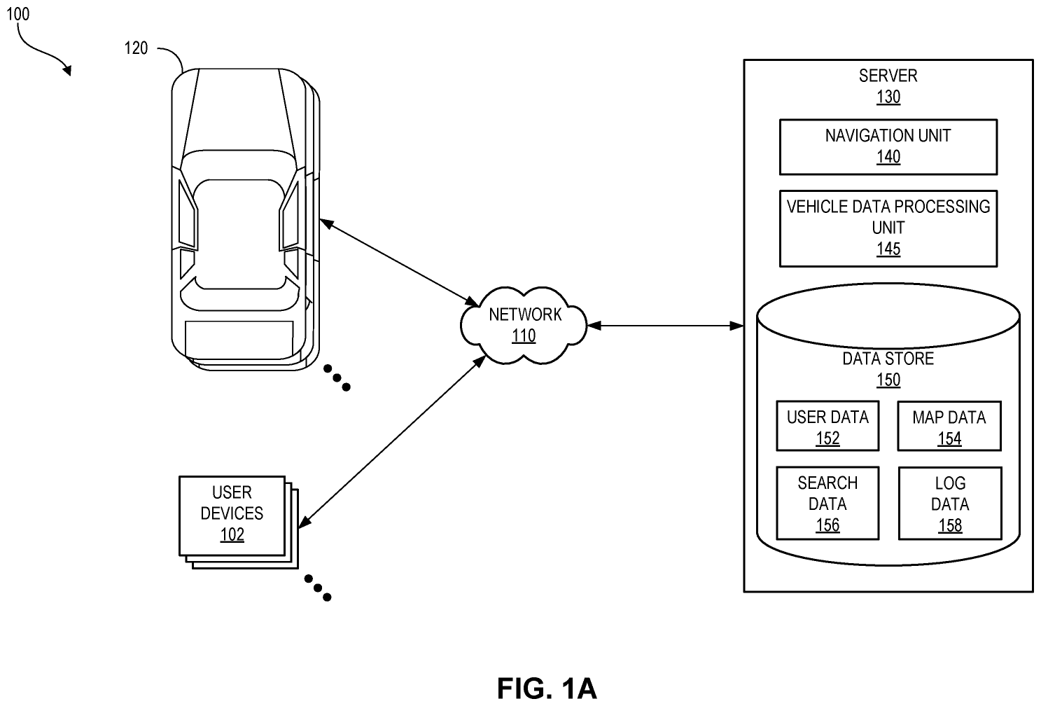

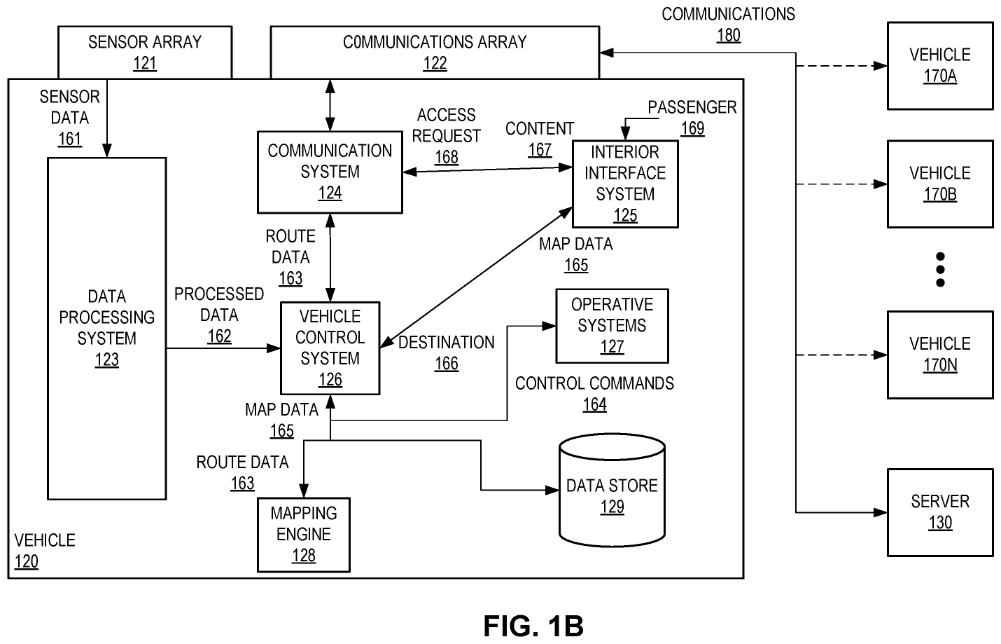

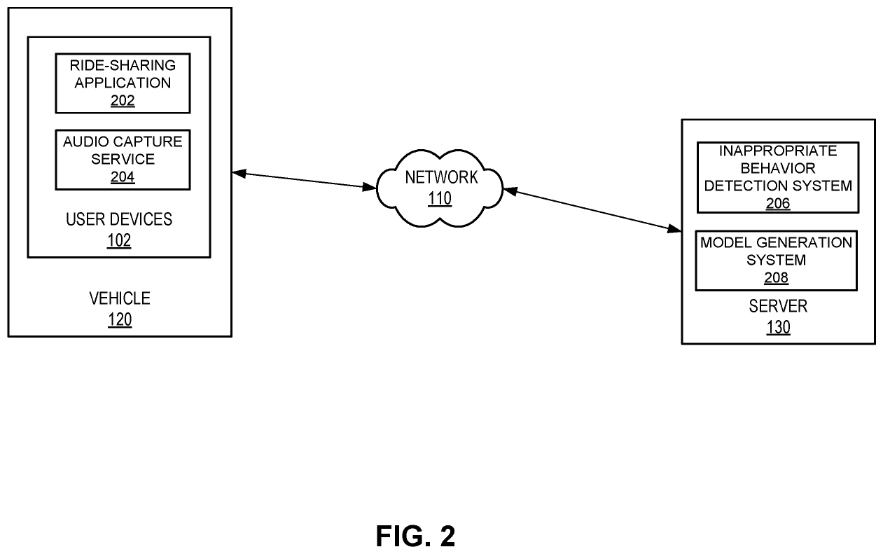

Detailed descriptions and examples of systems and methods according to one or more illustrative embodiments of the present disclosure may be found, at least, in the section entitled Inappropriate Behavior Detection System, as well as in the section entitled Example Embodiments, and also in FIGS. 2-9 herein. Furthermore, components and functionality for an inappropriate behavior detection system may be configured and/or incorporated into the networked vehicle environment 100 described herein in FIGS. 1A-1B.

Various embodiments described herein are intimately tied to, enabled by, and would not exist except for, vehicle and/or computer technology. For example, real-time machine learning based inappropriate behavior detection described herein in reference to various embodiments cannot reasonably be performed by humans alone, without the vehicle and/or computer technology upon which they are implemented.

### Networked Vehicle Environment

FIG. 1A illustrates a block diagram of a networked vehicle environment 100 in which one or more vehicles 120 and/or one or more user devices 102 interact with a server 130 via a network 110, according to certain aspects of the present disclosure. For example, the vehicles 120 may be equipped to provide ride-sharing and/or other location-based services, to assist drivers in controlling vehicle operation (e.g., via various driver-assist features, such as adaptive and/or regular cruise control, adaptive headlight control, anti-lock braking, automatic parking, night vision, blind spot monitor, collision avoidance, crosswind stabilization, driver drowsiness detection, driver monitoring system, emergency driver assistant, intersection assistant, hill descent control, intelligent speed adaptation, lane centering, lane departure warning, forward, rear, and/or side parking sensors, pedestrian detection, rain sensor, surround view system, tire pressure monitor, traffic sign recognition, turning assistant, wrong-way driving warning, traffic condition alerts, etc.), and/or to fully control vehicle operation. Thus, the vehicles 120 can be regular gasoline, natural gas, biofuel, electric, hydrogen, etc. vehicles configured to offer ride-sharing and/or other location-based services, vehicles that provide driver-assist functionality (e.g., one or more of the driver-assist features described herein), and/or automated or autonomous vehicles (AVs). The vehicles 120 can be automobiles, trucks, vans, buses, motorcycles, scooters, bicycles, and/or any other motorized vehicle.

The server 130 can communicate with the vehicles 120 to obtain vehicle data, such as route data, sensor data, perception data, vehicle 120 control data, vehicle 120 component fault and/or failure data, etc. The server 130 can process and store the vehicle data for use in other operations performed by the server 130 and/or another computing system (not shown). Such operations can include running diagnostic models to identify vehicle 120 operational issues (e.g., the cause of vehicle 120 navigational errors, unusual sensor readings, an object not being identified, vehicle 120 component failure, etc.); running models to simulate vehicle 120 performance given a set of variables; identifying objects that cannot be identified by a vehicle 120, generating control instructions that, when executed by a vehicle 120, cause the vehicle 120 to drive and/or maneuver in a certain manner along a specified path; and/or the like.

The server 130 can also transmit data to the vehicles 120. For example, the server 130 can transmit map data, firmware and/or software updates, vehicle 120 control instructions, an identification of an object that could not otherwise be identified by a vehicle 120, passenger pickup information, traffic data, and/or the like.

In addition to communicating with one or more vehicles 120, the server 130 can communicate with one or more user devices 102. In particular, the server 130 can provide a network service to enable a user to request, via an application running on a user device 102, location-based services (e.g., transportation services, such as ride-sharing services). For example, the user devices 102 can correspond to a computing device, such as a smart phone, tablet, laptop, smart watch, or any other device that can communicate over the network 110 with the server 130. A user device 102 can execute an application, such as a mobile application, that the user operating the user device 102 can use to interact with the server 130. For example, the user device 102 can communicate with the server 130 to provide location data and/or queries to the server 130, to receive map-related data and/or directions from the server 130, and/or the like.

The server 130 can process requests and/or other data received from user devices 102 to identify service providers (e.g., vehicle 120 drivers) to provide the requested services for the users. In addition, the server 130 can receive data—such as user trip pickup or destination data, user location query data, etc.—based on which the server 130 identifies a region, an address, and/or other location associated with the various users. The server 130 can then use the identified location to provide services providers and/or users with directions to a determined pickup location.

The application running on the user device 102 may be created and/or made available by the same entity responsible for the server 130. Alternatively, the application running on the user device 102 can be a third-party application that includes features (e.g., an application programming interface or software development kit) that enables communications with the server 130.

A single server 130 is illustrated in FIG. 1A for simplicity and ease of explanation. It is appreciated, however, that the server 130 may be a single computing device, or may include multiple distinct computing devices logically or physically grouped together to collectively operate as a server system. The components of the server 130 can be implemented in application-specific hardware (e.g., a server computing device with one or more ASICs) such that no software is necessary, or as a combination of hardware and software. In addition, the modules and components of the server 130 can be combined on one server computing device or separated individually or into groups on several server computing devices. The server 130 may include additional or fewer components than illustrated in FIG. 1A.

The network 110 includes any wired network, wireless network, or combination thereof. For example, the network 110 may be a personal area network, local area network, wide area network, over-the-air broadcast network (e.g., for radio or television), cable network, satellite network, cellular telephone network, or combination thereof. As a further example, the network 110 may be a publicly accessible network of linked networks, possibly operated by various distinct parties, such as the Internet. The network 110 may be a private or semi-private network, such as a corporate or university intranet. The network 110 may include one or more wireless networks, such as a Global System for Mobile Communications (GSM) network, a Code Division Multiple Access (CDMA) network, a Long Term Evolution (LTE) network, or any other type of wireless network. The network 110 can use protocols and components for communicating via the Internet or any of the other aforementioned types of networks. For example, the protocols used by the network 110 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The server 130 can include a navigation unit 140, a vehicle data processing unit 145, and a data store 150. The navigation unit 140 can assist with location-based services. For example, the navigation unit 140 can facilitate the transportation of a user (also referred to herein as a “rider”) and/or an object (e.g., food, packages, etc.) by another user (also referred to herein as a “driver”) from a first location (also referred to herein as a “pickup location”) to a second location (also referred to herein as a “destination location”). The navigation unit 140 may facilitate user and/or object transportation by providing map and/or navigation instructions to an application running on a user device 102 of a rider, to an application running on a user device 102 of a driver, and/or to a navigational system running on a vehicle 120.

As an example, the navigation unit 140 can include a matching service (not shown) that pairs a rider requesting a trip from a pickup location to a destination location with a driver that can complete the trip. The matching service may interact with an application running on the user device 102 of the rider and/or an application running on the user device 102 of the driver to establish the trip for the rider and/or to process payment from the rider to the driver.

The navigation unit 140 can also communicate with the application running on the user device 102 of the driver during the trip to obtain trip location information from the user device 102 (e.g., via a global position system (GPS) component coupled to and/or embedded within the user device 102) and provide navigation directions to the application that aid the driver in traveling from the current location of the driver to the destination location. The navigation unit 140 can also direct the driver to various geographic locations or points of interest, regardless of whether the driver is carrying a rider.

The vehicle data processing unit 145 can be configured to support vehicle 120 driver-assist features and/or to support autonomous driving. For example, the vehicle data processing unit 145 can generate and/or transmit to a vehicle 120 map data, run diagnostic models to identify vehicle 120 operational issues, run models to simulate vehicle 120 performance given a set of variables, use vehicle data provided by a vehicle 120 to identify an object and transmit an identification of the object to the vehicle 120, generate and/or transmit to a vehicle 120 vehicle 120 control instructions, and/or the like.

The data store 150 can store various types of data used by the navigation unit 140, the vehicle data processing unit 145, the user devices 102, and/or the vehicles 120. For example, the data store 150 can store user data 152, map data 154, search data 156, and log data 158.

The user data 152 may include information on some or all of the users registered with a location-based service, such as drivers and riders. The information may include, for example, usernames, passwords, names, addresses, billing information, data associated with prior trips taken or serviced by a user, user rating information, user loyalty program information, and/or the like.

The map data 154 may include high definition (HD) maps generated from sensors (e.g., light detection and ranging (LiDAR) sensors, radio detection and ranging (RADAR) sensors, infrared cameras, visible light cameras, stereo cameras, an inertial measurement unit (IMU), etc.), satellite imagery, optical character recognition (OCR) performed on captured street images (e.g., to identify names of streets, to identify street sign text, to identify names of points of interest, etc.), etc.; information used to calculate routes; information used to render 2D and/or 3D graphical maps; and/or the like. For example, the map data 154 can include elements like the layout of streets and intersections, bridges (e.g., including information on the height and/or width of bridges over streets), off-ramps, buildings, parking structure entrances and exits (e.g., including information on the height and/or width of the vehicle entrances and/or exits), the placement of street signs and stop lights, emergency turnoffs, points of interest (e.g., parks, restaurants, fuel stations, attractions, landmarks, etc., and associated names), road markings (e.g., centerline markings dividing lanes of opposing traffic, lane markings, stop lines, left turn guide lines, right turn guide lines, crosswalks, bus lane markings, bike lane markings, island marking, pavement text, highway exist and entrance markings, etc.), curbs, rail lines, waterways, turning radiuses and/or angles of left and right turns, the distance and dimensions of road features, the placement of barriers between two-way traffic, and/or the like, along with the elements' associated geographical locations (e.g., geographical coordinates). The map data 154 can also include reference data, such as real-time and/or historical traffic information, current and/or predicted weather conditions, road work information, information regarding laws and regulations (e.g., speed limits, whether right turns on red lights are permitted or prohibited, whether U-turns are permitted or prohibited, permitted direction of travel, and/or the like), news events, and/or the like.

While the map data 154 is illustrated as being stored in the data store 150 of the server 130, this is not meant to be limiting. For example, the server 130 can transmit the map data 154 to a vehicle 120 for storage therein (e.g., in the data store 129, described below).

The search data 156 can include searches entered by various users in the past. For example, the search data 156 can include textual searches for pickup and/or destination locations. The searches can be for specific addresses, geographical locations, names associated with a geographical location (e.g., name of a park, restaurant, fuel station, attraction, landmark, etc.), etc.

The log data 158 can include vehicle data provided by one or more vehicles 120. For example, the vehicle data can include route data, sensor data, perception data, vehicle 120 control data, vehicle 120 component fault and/or failure data, etc.

FIG. 1B illustrates a block diagram showing the vehicle 120 of FIG. 1A in communication with one or more other vehicles 170A-N and/or the server 130 of FIG. 1A, according to certain aspects of the present disclosure. As illustrated in FIG. 1B, the vehicle 120 can include various components and/or data stores. For example, the vehicle 120 can include a sensor array 121, a communications array 122, a data processing system 123, a communication system 124, an interior interface system 125, a vehicle control system 126, operative systems 127, a mapping engine 128, and/or a data store 129.

Communications 180 may be transmitted and/or received between the vehicle 120, one or more vehicles 170A-N, and/or the server 130. The server 130 can transmit and/or receive data from the vehicle 120 as described above with respect to FIG. 1A. For example, the server 130 can transmit vehicle control instructions or commands (e.g., as communications 180) to the vehicle 120. The vehicle control instructions can be received by the communications array 122 (e.g., an array of one or more antennas configured to transmit and/or receive wireless signals), which is operated by the communication system 124 (e.g., a transceiver). The communication system 124 can transmit the vehicle control instructions to the vehicle control system 126, which can operate the acceleration, steering, braking, lights, signals, and other operative systems 127 of the vehicle 120 in order to drive and/or maneuver the vehicle 120 and/or assist a driver in driving and/or maneuvering the vehicle 120 through road traffic to destination locations specified by the vehicle control instructions.

As an example, the vehicle control instructions can include route data 163, which can be processed by the vehicle control system 126 to maneuver the vehicle 120 and/or assist a driver in maneuvering the vehicle 120 along a given route (e.g., an optimized route calculated by the server 130 and/or the mapping engine 128) to the specified destination location. In processing the route data 163, the vehicle control system 126 can generate control commands 164 for execution by the operative systems 127 (e.g., acceleration, steering, braking, maneuvering, reversing, etc.) to cause the vehicle 120 to travel along the route to the destination location and/or to assist a driver in maneuvering the vehicle 120 along the route to the destination location.

A destination location 166 may be specified by the server 130 based on user requests (e.g., pickup requests, delivery requests, etc.) transmitted from applications running on user devices 102. Alternatively or in addition, a passenger and/or driver of the vehicle 120 can provide user input(s) 169 through an interior interface system 125 (e.g., a vehicle navigation system) to provide a destination location 166. The vehicle control system 126 can transmit the inputted destination location 166 and/or a current location of the vehicle 120 (e.g., as a GPS data packet) as a communication 180 to the server 130 via the communication system 124 and the communications array 122. The server 130 (e.g., the navigation unit 140) can use the current location of the vehicle 120 and/or the inputted destination location 166 to perform an optimization operation to determine an optimal route for the vehicle 120 to travel to the destination location 166. Route data 163 that includes the optimal route can be transmitted from the server 130 to the vehicle control system 126 via the communications array 122 and the communication system 124. As a result of receiving the route data 163, the vehicle control system 126 can cause the operative systems 127 to maneuver the vehicle 120 through traffic to the destination location 166 along the optimal route, assist a driver in maneuvering the vehicle 120 through traffic to the destination location 166 along the optimal route, and/or cause the interior interface system 125 to display and/or present instructions for maneuvering the vehicle 120 through traffic to the destination location 166 along the optimal route.

Alternatively or in addition, the route data 163 includes the optimal route and the vehicle control system 126 automatically inputs the route data 163 into the mapping engine 128. The mapping engine 128 can generate map data 165 using the optimal route (e.g., generate a map showing the optimal route and/or instructions for taking the optimal route) and provide the map data 165 to the interior interface system 125 (e.g., via the vehicle control system 126) for display. The map data 165 may include information derived from the map data 154 stored in the data store 150 on the server 130. The displayed map data 165 can indicate an estimated time of arrival and/or show the progress of the vehicle 120 along the optimal route. The displayed map data 165 can also include indicators, such as reroute commands, emergency notifications, road work information, real-time traffic data, current weather conditions, information regarding laws and regulations (e.g., speed limits, whether right turns on red lights are permitted or prohibited, where U-turns are permitted or prohibited, permitted direction of travel, etc.), news events, and/or the like.

The user input 169 can also be a request to access a network (e.g., the network 110). In response to such a request, the interior interface system 125 can generate an access request 168, which can be processed by the communication system 124 to configure the communications array 122 to transmit and/or receive data corresponding to a user's interaction with the interior interface system 125 and/or with a user device 102 in communication with the interior interface system 125 (e.g., a user device 102 connected to the interior interface system 125 via a wireless connection). For example, the vehicle 120 can include on-board Wi-Fi, which the passenger(s) and/or driver can access to send and/or receive emails and/or text messages, stream audio and/or video content, browse content pages (e.g., network pages, web pages, etc.), and/or access applications that use network access. Based on user interactions, the interior interface system 125 can receive content 167 via the network 110, the communications array 122, and/or the communication system 124. The communication system 124 can dynamically manage network access to avoid or minimize disruption of the transmission of the content 167.

The sensor array 121 can include any number of one or more types of sensors, such as a satellite-radio navigation system (e.g., GPS), a LiDAR sensor, a landscape sensor (e.g., a radar sensor), an IMU, a camera (e.g., an infrared camera, a visible light camera, stereo cameras, etc.), a Wi-Fi detection system, a cellular communication system, an inter-vehicle communication system, a road sensor communication system, feature sensors, proximity sensors (e.g., infrared, electromagnetic, photoelectric, etc.), distance sensors, depth sensors, and/or the like. The satellite-radio navigation system may compute the current position (e.g., within a range of 1-10 meters) of the vehicle 120 based on an analysis of signals received from a constellation of satellites.

The LiDAR sensor, the radar sensor, and/or any other similar types of sensors can be used to detect the vehicle 120 surroundings while the vehicle 120 is in motion or about to begin motion. For example, the LiDAR sensor may be used to bounce multiple laser beams off approaching objects to assess their distance and to provide accurate 3D information on the surrounding environment. The data obtained from the LiDAR sensor may be used in performing object identification, motion vector determination, collision prediction, and/or in implementing accident avoidance processes. Optionally, the LiDAR sensor may provide a 360° view using a rotating, scanning mirror assembly. The LiDAR sensor may optionally be mounted on a roof of the vehicle 120.

The IMU may include X, Y, Z oriented gyroscopes and/or accelerometers. The IMU provides data on the rotational and linear motion of the vehicle 120, which may be used to calculate the motion and position of the vehicle 120.

Cameras may be used to capture visual images of the environment surrounding the vehicle 120. Depending on the configuration and number of cameras, the cameras may provide a 360° view around the vehicle 120. The images from the cameras may be used to read road markings (e.g., lane markings), read street signs, detect objects, and/or the like.

The Wi-Fi detection system and/or the cellular communication system may be used to perform triangulation with respect to Wi-Fi hot spots or cell towers respectively, to determine the position of the vehicle 120 (optionally in conjunction with then satellite-radio navigation system).

The inter-vehicle communication system (which may include the Wi-Fi detection system, the cellular communication system, and/or the communications array 122) may be used to receive and/or transmit data to the other vehicles 170A-N, such as current speed and/or location coordinates of the vehicle 120, time and/or location coordinates corresponding to when deceleration is planned and the planned rate of deceleration, time and/or location coordinates when a stop operation is planned, time and/or location coordinates when a lane change is planned and direction of lane change, time and/or location coordinates when a turn operation is planned, time and/or location coordinates when a parking operation is planned, and/or the like.

The road sensor communication system (which may include the Wi-Fi detection system and/or the cellular communication system) may be used to read information from road sensors (e.g., indicating the traffic speed and/or traffic congestion) and/or traffic control devices (e.g., traffic signals).

When a user requests transportation (e.g., via the application running on the user device 102), the user may specify a specific destination location. The origination location may be the current location of the vehicle 120, which may be determined using the satellite-radio navigation system installed in the vehicle (e.g., GPS, Galileo, BeiDou/COMPASS, DORIS, GLONASS, and/or other satellite-radio navigation system), a Wi-Fi positioning System, cell tower triangulation, and/or the like. Optionally, the origination location may be specified by the user via a user interface provided by the vehicle 120 (e.g., the interior interface system 125) or via the user device 102 running the application. Optionally, the origination location may be automatically determined from location information obtained from the user device 102. In addition to the origination location and destination location, one or more waypoints may be specified, enabling multiple destination locations.

Raw sensor data 161 from the sensor array 121 can be processed by the on-board data processing system 123. The processed data 162 can then be sent by the data processing system 123 to the vehicle control system 126, and optionally sent to the server 130 via the communication system 124 and the communications array 122.

The data store 129 can store map data (e.g., the map data 154) and/or a subset of the map data 154 (e.g., a portion of the map data 154 corresponding to a general region in which the vehicle 120 is currently located). The vehicle 120 can use the sensor array 121 to record updated map data along traveled routes, and transmit the updated map data to the server 130 via the communication system 124 and the communications array 122. The server 130 can then transmit the updated map data to one or more of the vehicles 170A-N and/or further process the updated map data.

The data processing system 123 can provide continuous or near continuous processed data 162 to the vehicle control system 126 to respond to point-to-point activity in the surroundings of the vehicle 120. The processed data 162 can comprise comparisons between the raw sensor data 161—which represents an operational environment of the vehicle 120, and which is continuously collected by the sensor array 121—and the map data stored in the data store 129. In an example, the data processing system 123 is programmed with machine learning or other artificial intelligence capabilities to enable the vehicle 120 to identify and respond to conditions, events, and/or potential hazards. In variations, the data processing system 123 can continuously or nearly continuously compare raw sensor data 161 to stored map data in order to perform a localization to continuously or nearly continuously determine a location and/or orientation of the vehicle 120. Localization of the vehicle 120 may allow the vehicle 120 to become aware of an instant location and/or orientation of the vehicle 120 in comparison to the stored map data in order to maneuver the vehicle 120 on surface streets through traffic and/or assist a driver in maneuvering the vehicle 120 on surface streets through traffic and identify and respond to potential hazards (e.g., pedestrians) or local conditions, such as weather or traffic conditions.

Furthermore, localization can enable the vehicle 120 to tune or beam steer the communications array 122 to maximize a communication link quality and/or to minimize interference with other communications from other vehicles 170A-N. For example, the communication system 124 can beam steer a radiation patterns of the communications array 122 in response to network configuration commands received from the server 130. The data store 129 may store current network resource map data that identifies network base stations and/or other network sources that provide network connectivity. The network resource map data may indicate locations of base stations and/or available network types (e.g., 3G, 4G, LTE, Wi-Fi, etc.) within a region in which the vehicle 120 is located.

While FIG. 1B describes certain operations as being performed by the vehicle 120 or the server 130, this is not meant to be limiting. The operations performed by the vehicle 120 and the server 130 as described herein can be performed by either entity. For example, certain operations normally performed by the server 130 (e.g., transmitting updating map data to the vehicles 170A-N) may be performed by the vehicle 120 for load balancing purposes (e.g., to reduce the processing load of the server 130, to take advantage of spare processing capacity on the vehicle 120, etc.).

Furthermore, any of the vehicles 170A-N may include some or all of the components of the vehicle 120 described herein. For example, a vehicle 170A-N can include a communications array 122 to communicate with the vehicle 120 and/or the server 130.

### Inappropriate Behavior Detection System

As described above, it is desirable to detect inappropriate behavior in real-time or near real-time (e.g., within seconds or minutes, or before the completion of a ride-sharing event) so that the inappropriate behavior (e.g., requesting a driver or passenger's contact information) can be stopped and/or appropriate action (e.g., contacting the police or other authorities) can be taken. Aspects of the present disclosure perform inappropriate behavior detection, and more specifically contact information request detection, using artificial intelligence models that may be trained using data points labeled using patterns and/or data points labeled manually. In some aspects, non-verbal inappropriate behavior may be detected using audio data. For example, physical coercion of information may be detected based on speech and/or sounds associated with an occurrence of physical coercion.

The artificial intelligence models may include text classification models (e.g., HAN models, CNN models, etc.) that are trained by an adaptation model using one or more artificial intelligence algorithms. The adaptation model may use a trained text classification model to output a prediction of whether certain audio includes or indicates an occurrence of inappropriate behavior. Some non-limiting examples of artificial intelligence algorithms that can be used to generate and update the text classification models can include supervised and non-supervised machine learning algorithms, including regression algorithms (such as, for example, Ordinary Least Squares Regression), instance-based algorithms (such as, for example, Learning Vector Quantization), decision tree algorithms (such as, for example, classification and regression trees), Bayesian algorithms (such as, for example, Naive Bayes), clustering algorithms (such as, for example, k-means clustering), association rule learning algorithms (such as, for example, Apriori algorithms), artificial neural network algorithms (such as, for example, Perceptron), deep learning algorithms (such as, for example, Deep Boltzmann Machine), dimensionality reduction algorithms (such as, for example, Principal Component Analysis), ensemble algorithms (such as, for example, Stacked Generalization), and/or other machine learning algorithms.

### Example Networked Computing Environment With Inappropriate Behavior Detection

FIG. 2 illustrates a block diagram showing additional and/or alternative details of the networked vehicle environment of FIG. 1A in accordance with certain aspects of the present disclosure. The networked vehicle environment 200 may include one or more of the embodiments previously described with respect to the networked vehicle environment 100.

The networked vehicle environment 200 may include a vehicle 120. The vehicle 120 may include one or more user devices 102. These user devices 102 may be separate devices from the vehicle 120 that are brought into the vehicle by one or more users. For example, the user devices 102 may include cell phones (e.g., smart phones), tablets, laptops, or other devices that can execute a ride-sharing application and/or communicate over a network 110 with a server 130. Although typically independent of the vehicle 120, in some cases, the user devices 102 may interface with the vehicle 120. For example, a user device 102 may communicate map information or directions to a display on the vehicle 120. In some cases, the user device 102 may be part of the vehicle 120.

At least some of the user devices 102 may have, may host, and/or may execute a ride-sharing application 202. The ride-sharing application 202 may include any application that enables a user to request a ride from an autonomous vehicle, a semi-autonomous vehicle (e.g., vehicles that provide driver-assist functionality), and/or another user that is participating in a ride-sharing service as a driver and/or that has a user device 102 with the ride-sharing application 202.

Further, the user device 102 may include an audio capture service 204. The audio capture service 204 may be part of the ride-sharing application 202 or may be separate, but accessible by, the ride-sharing application 202. The audio capture service 204 may include any service or application hosted and/or executed by the user device 102 that is capable of capturing speech or other utterances using one or more microphones of the user device 102. In some cases, the utterances may be captured by microphones within the vehicle 120 with which the user device 102 is capable of interfacing.

In some cases, the audio capture service 204 and/or the user devices 102 may have one or more hardware and/or software filters. The filters may be configured to remove ambient noise and utterances that are determined to be generated by non-human users or users not located within the vehicle 120. For example, navigation directions output by the user device 102 or other devices within the vehicle 120 may be filtered from the audio captured by the audio capture service 204. As another example, audio generated by a radio, sounds generated by animals, or utterances spoken by people external to the vehicle 120 may, in some cases, be filtered from audio captured by the audio capture service 204. Utterances may include any speech made by a user. Further, in some cases, utterances may include any sounds or communications made by a user's mouth including both speech and non-speech. The filters may be configured to identify and remove ambient noise and utterances generated by non-human users or users not located within the vehicle 120 based on the volume of the detected sound (e.g., if the decibels of the detected sound are below a threshold level, this may indicate ambient noise or utterances by a user that is some distance away and not in the vehicle 120), based on the tone, frequency, or pitch of the detected sound (e.g., navigation directions may be output by a monotone voice), based on the words or sounds that are uttered (e.g., audio corresponding to navigation directions may involve the utterance of certain keywords or phrases, such as “turn,” “in 100 feet,” “in half a mile,” “merge,” “freeway,” “highway,” etc.; audio corresponding to a radio may include words or phrases indicating that a song is about to be played, that a commercial break is about to start, etc.; audio corresponding to a radio may include static noise that may originate from poor reception or interference; audio corresponding to an animal may match a certain audio pattern accessible by the filters, such as an audio pattern that represents a chirp uttered by a particular type of bird, an audio pattern that represents a bark uttered by a particular type of dog, etc.; and/or the like), and/or the like.

The user devices 102 may communicate with a server 130 via a network 110 to provide captured audio to the server 130, such as to an inappropriate behavior detection system 206 of the server 130. The inappropriate behavior detection system 206 may determine whether audio captured by the audio capture service 204 indicates that a user (e.g., a passenger, a driver, etc.) is being subjected to inappropriate behavior by another user (e.g., a driver, a passenger, etc.) within the vehicle. The inappropriate behavior detection system 206 can determine whether a user is being subjected to inappropriate behavior by applying audio received from the audio capture service 204 to an adaptation model run by the inappropriate behavior detection system 206.

The model generation system 208 may pre-train and train a text classification model using one or more artificial intelligence algorithms. The artificial intelligence algorithms may use historical data to pre-train and/or train the text classification model. The historical data may include text converted from audio segments in which inappropriate behavior is uttered and text converted from audio segments in which appropriate behavior is uttered. Further, the historical data may include reports, labels, and/or annotations regarding the text included in the historical data that indicate inappropriate behavior, types of inappropriate behavior, level of inappropriate behavior, and any other information that may facilitate the identification of an occurrence of inappropriate behavior (including indications of appropriate behavior).

The combination of the audio capture service 204, the ride-sharing application 202, the inappropriate behavior detection system 206, and the model generation system 208 may form a safety incidence detection system that can be used to identify inappropriate behavior and to initiate a countermeasure, such as contacting authorities or blocking a user from using the ride-sharing application 202 or an account on the ride-sharing application 202. Further, in some cases, the location positioning system (e.g., global positioning system or GPS) of the user device 102 may be used to assist authorities in locating a user that is behaving inappropriately with one or more other users.

### Example Safety Incidence Detection System

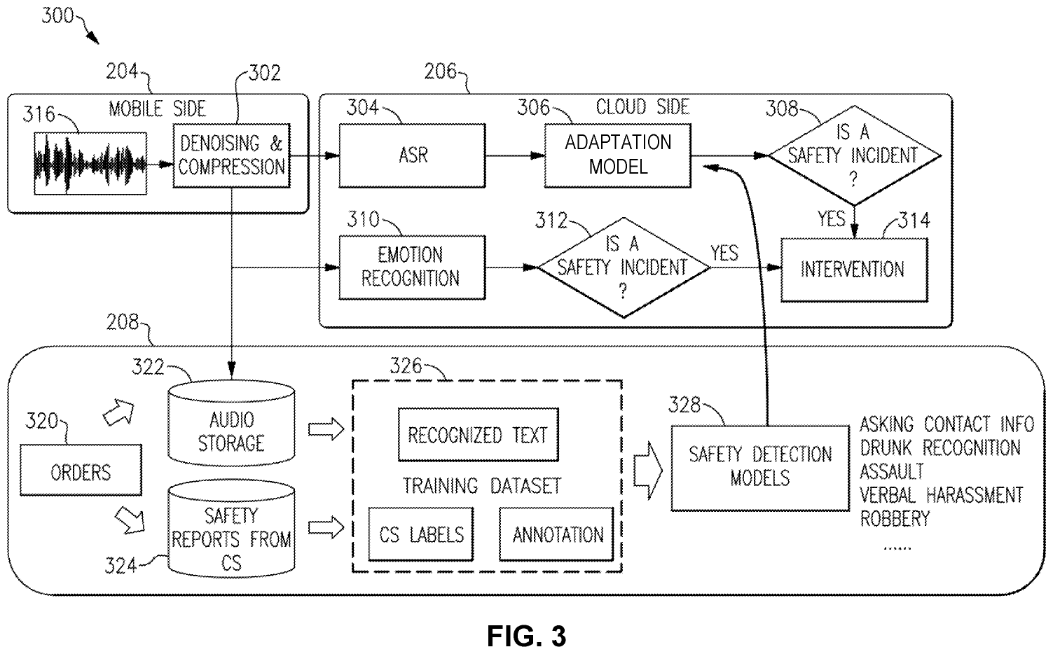

FIG. 3 illustrates a block diagram of operation of a safety incidence detection system 300 in accordance with certain aspects of the present disclosure. As described above, the safety incidence detection system 300 may be formed from a user device 102 (or an audio capture service 204 of the user device 102) and an inappropriate behavior detection system 206. The user device 102 may be a user device of a ride-sharing driver or a ride-sharing passenger. In some cases, user devices 102 of both drivers and passengers may be included as part of the system 300. Further, the system 300 may include a model generation system 208 that pre-trains and/or trains one or more text classification models for use by the inappropriate behavior detection system 206.

The audio capture service 204 of the user device 102 may capture audio 316 or sound within a target area (e.g., in a vehicle). The audio capture service 204 may be on a driver's device, a passenger's device, or both. The target area is typically, although not limited to, a vehicle 120, or other enclosed space. The captured audio 316 may include utterances from users within the target area, utterances from users within a particular distance of the target area (e.g., a range of a microphone of the user device 102), ambient noise within the vehicle 120 (or in some cases external to the vehicle 120, but within range of a microphone of the user device 102), navigation instructions output by the ride-sharing application 202 or other navigation application, sound from a radio or other audio/visual device operating within the vehicle 120, sounds from non-human animals (e.g., pets) within the vehicle 120, sounds from the vehicle 120, or any other sounds that can be detected by a microphone of the user device 102.

As previously described, the audio capture service 204 may be part of a ride-sharing application 202. Alternatively, the audio capture service 204 may be an independent service or application hosted by the user device 102. In some such cases, the audio capture service 204 may be accessible by the ride-sharing application 202. The audio capture service 204 may interact with one or more microphones of the user device 102 to capture audio 316 within the target area. Although many of the embodiments described herein are with respect to the ride-sharing application 202, it should be understood that a separate application from the ride-sharing application 202 may perform the operations described herein with respect to the ride-sharing application 202 for the purposes of harassment detection. For example, a separate application may be installed on one or more user devices 102 to facilitate detection of inappropriate behavior. The separate application may be required by an entity associated with the ride-sharing application 202 and may interact with the ride-sharing application 202. Alternatively, the separate application may be completely independent of the ride-sharing application 202.

The audio capture service 204 may include one or more filters 302 that can remove noise from the audio captured by the audio capture service 204. Further, in some cases, the filters 302 may include one or more compression systems capable of compressing the captured audio before it is communicated over the network 110 to the inappropriate behavior detection system 206 at the server 130. Removing the noise may include filtering out non-utterances, removing audio related to navigation, or removing any other audio that can be determined to be from other than users within the vehicle 120. The filters 302 may identify the noise for removal based on some or all of the factors described above.

Filtering audio or sounds that are generated from sources other than users within the vehicle 120 can be challenging. The filtering process may include removing frequencies that are not typically generated by users' utterances or removing sounds that are determined to be associated with sources other than users' utterances. Sounds relating to navigation can typically be determined a priori because the ride-sharing application 202, or other navigation application, generates a known output (e.g., audio associated with spoken directions) based on a known input (e.g., the directions determined by the ride-sharing application 202). Thus, as the output relating to navigation that is output from the ride-sharing application 202 is known, the ride-sharing application 202 (e.g., the audio capture service 204) may expect to receive certain audio associated with specific navigation instructions as an input, and thus the expected audio input can be filtered accordingly. It should be understood that the actual input associated with the navigation audio received by the microphone of the user device 102 may vary from the expected input due to differences of the layout of each vehicle 120, items within the vehicle 120, positioning of users within the vehicle 120, positioning of the user device 102, and the like. However, as more audio relating to navigation audio is captured over time by the audio capture service 204, the filtering of the navigation audio from the total audio captured by the audio capture service 204 can be improved by using one or more machine learning algorithms to update the expected input for the navigation audio.

Although the filtering is described as being performed by the audio capture service 204, in some cases the filtering may be performed by the inappropriate behavior detection system 206. Further, in some cases some of the filtering may be performed by the audio capture service 204 and some of the filtering may be performed by the inappropriate behavior detection system 206. For example, filtering of the navigation audio may be performed on the user device 102 by the audio capture service 204. However, filtering of ambient noise, radio, or other sounds generated by sources other than the users in the vehicle 120 may be performed by the inappropriate behavior detection system 206. The filters of the audio capture service 204 and/or the inappropriate behavior detection system 206 may include both hardware-based filters and software-based filters.

In some cases, the audio captured by the audio capture service 204 may be divided into segments. These segments may be time-based or size-based. For example, the audio segments may be divided into 30 second, one minute, five minute, seven minute, or 10 minute segments. Alternatively, or in addition, the audio segments may be divided into files of a particular size, such as 10 MB, 20 MB, 50 MB, 512 MB, 1 GB, etc.

The audio segments, or the filtered audio segments, may be provided to the inappropriate behavior detection system 206 over a network 110. As previously indicated, in some cases, the inappropriate behavior detection system 206 may perform filtering or additional filtering. Regardless of whether filtered at the audio capture service 204, the inappropriate behavior detection system 206 or both systems, the filtered audio may be provided to an automatic speech recognition (ASR) system 304. The ASR system 304 may convert the received audio to text. The ASR system 304 may include any type of system or algorithm for converting audio to text. For example, the ASR system 304 may include using hidden Markov models or deep learning models to convert the speech included in an audio segment to text.

The text generated by the ASR system 304 may be provided to an adaptation model 306 to predict whether the text includes utterances indicative of inappropriate behavior. The adaptation model 306 may be configured to provide the text as an input to a trained text classification model to generate a prediction. As described herein, the text classification model may be pre-trained and/or trained by the model generation system 208, the adaptation model 306, and/or a combination thereof. The prediction output by the adaptation model 306 may be a value associated with a likelihood or probability that the text includes utterances indicative of inappropriate behavior. Based on the prediction output by the adaptation model 306, the inappropriate behavior detection system 206 may determine at the decision block 308 whether inappropriate behavior, or some other incident associated with a request for a user's contact information, has occurred.

Determining whether inappropriate behavior has occurred may include comparing the output of the adaptation model 306 to a threshold. Optionally, the threshold may vary based on additional factors, such as an emotion detected by an emotion detector or an emotion recognition engine 310. For example, the emotion recognition engine 310 may receive the audio segment from the audio capture service 204. While the adaptation model 306 may process text obtained by the ASR system 304 converting the received audio segment, the emotion recognition engine 310 may process the audio segment, filtered or otherwise, directly.

The emotion recognition engine 310 may determine an emotion of the user that generated an utterance included in the audio segment. The emotion of the user may be determined using one or more machine learning models. For example, the emotion of the user may be determined using a support vector machine, a hidden Markov model, or a deep learning model, such as a deep feed-forward and recurrent neural networks, or convolutional neural networks. The emotion of the user may be detected by the machine learning model(s) based on the tone, pitch, frequency, volume, or other audio characteristics of the audio segment.

Using the emotion of the user determined by the emotion recognition engine 310, the inappropriate behavior detection system 206 may determine at the decision block 312 whether there is a safety incident or an incidence of inappropriate behavior. For example, if the emotion recognition engine 310 determines that the user appears to be distressed, frightened, hesitant, or angry, the inappropriate behavior detection system 206 may determine that the user is being subjected to inappropriate behavior. If it is determined that either of the decision blocks 308 or 312 indicate a likelihood of inappropriate behavior, the inappropriate behavior detection system 206 may initiate a countermeasure or cause an intervention to be performed at the block 314. These countermeasures may include contacting the victim user to confirm an inappropriate behavior event, contacting an authority (e.g., police) to obtain assistance for the victim user, removing or blocking a perpetrator user from using the ride-sharing application 202, or performing any other intervention action to reduce or prevent further inappropriate behavior. In some cases, the intervention action 314 may include alerting a user, such as an administrator, of potential inappropriate behavior. The user may then review the audio segment and confirm whether inappropriate behavior is occurring before taking or initiating further intervention actions.

In some aspects of the inappropriate behavior detection system 206, the determination of whether inappropriate behavior or another type of inappropriate request for a user's contact information is occurring may be based on a combination of the prediction output by the adaptation model 306 and/or the emotion detected by the emotion recognition engine 310. By combining the detected emotion with the output of the adaptation model 306, it is possible to distinguish between a user who may be feeling that a contact information request is inappropriate and a user who may not be feeling that a contact information request is inappropriate. For example, a driver asking a passenger for personal contact information is typically inappropriate. However, it is possible in some cases that the passenger and the driver may have previously known each other and lost contact over time. In such cases, the driver asking the passenger for personal contact information may not be inappropriate, but may be an effort for two prior acquaintances to become reconnected. These two use cases may be distinguished based on the emotion of the user making the utterance or responding to the utterance. Accordingly, in some cases, the use of emotion detection in combination with the inappropriate behavior prediction enables improved detection of inappropriate behavior.

In some aspects of the inappropriate behavior detection system 206, the emotion detected by the emotion recognition engine 310 may be provided to the adaptation model 306 as an additional input to the text classification model or a separate model. Based on the detected emotion and the text obtained by the ASR system 304, the adaptation model 306 may determine a likelihood or probability that a user is being subjected to inappropriate behavior.

The text classification model used by the adaptation model 306 may be generated by a model generation system 208, the adaptation model 306, and/or a combination of the two. The model generation system 208 and/or adaptation model 306 may use one or more artificial intelligence algorithms to generate the text classification model based on a set of training data 326 and one or more patterns. For example, the model generation system 208 and/or the adaptation model 306 can obtain text corresponding to one or more audio segments (e.g., historical audio segments captured by one or more audio capture services 204 during previous ride-share events, sample audio segments generated by an administrator, sample audio segments obtained from a third party source, etc.) from the ASR system 304 and apply the pattern(s) to the text to label portions of the text that match at least one pattern and/or to label portions of the text that do not match any pattern. In some cases, the model generation system 208 and/or the adaptation model 306 can label the text corresponding to a single audio segment as either matching a pattern or not matching a pattern, and can repeat this process for some or all of the audio segments. Once labeled with patterns, the model generation system 208 and/or the adaptation model 306 can pre-train a text classification model using the pattern-labeled text as the training data. The model generation system 208 and/or the adaptation model 306 can then re-train or update the pre-trained text classification model using the set of manually-labeled training data 326 to form the trained text classification model.

The patterns may be generated manually or by the model generation system 208 and/or the adaptation model 306. The patterns may be rules-based patterns that each include one or more rules associated with a word, a phrase, a sentence, a combination of words, time of day of the ride-share, gender of a user, age of a user, destination of a user, origin of a user, and/or the like. A pattern may identify that inappropriate behavior has likely occurred if some or all of the rule(s) associated with the pattern are satisfied (or are not satisfied). As an illustrative example, a pattern may include a rule is satisfied if the phrase “tell me your address” is present in compared text. The pattern may therefore indicate that inappropriate behavior has likely occurred if the rule is satisfied (e.g., if the phrase “tell me your address” is present in the compared text).

The training data 326 may be obtained from different sources of historical data. The historical data may be obtained from real-world incidents. For example, the audio segments captured by the audio capture service 204, in addition to being provided to the inappropriate behavior detection system 206, may be provided to the model generation system 208 to facilitate generating the text classification models that are applied by the adaptation model 306.

The historical data may include a set of orders 320. Each order 320 may be associated with a ride-sharing event; for example, the pickup and drop-off of a user and a destination requested by the user via the ride-sharing application 202. Further, the order 320 may be associated with a safety report generated by a user (e.g., an administrator or customer service representative) or generated automatically in response to data entered by a user (e.g., a driver or passenger) into the ride-sharing application 202 or other interface made available by an entity associated with the ride-sharing application 202 for lodging a complaint or reporting on inappropriate behavior or a safety incident. In some cases, each order within the orders 320 is associated with a safety report regardless of whether inappropriate behavior occurred. In cases where inappropriate behavior did not occur, the safety report would indicate the lack of inappropriate behavior. In other cases, only orders within the orders 320 where inappropriate behavior occurred would be associated with a customer safety report. In some such cases, each order 320 may indicate whether a safety report exists or not. The safety report for each order 320 and/or the indication of an existence of a safety report for each order 320 may be stored at a safety report repository 324. Further, audio segments associated with each order 320 may be stored at an audio storage repository 322. The audio segments associated with a particular order 320 stored in the audio storage repository 322 may be linked to or otherwise have an indicator identifying any associated safety reports from the safety report repository 324. In some cases, the repository 322 and 324 may be combined into a single repository.

The data (e.g., the one or more audio segments, the safety reports, and/or the indication of an existence or lack thereof of a safety report) associated with each order 320 may form the training dataset 326 that can be applied to an artificial intelligence algorithm to generate one or more safety detection models 328, such as the trained text classification model described herein. In some cases, the training dataset 326 may include annotation data in addition to labels supplied by users (e.g., administrators or customer service employees). The customer service labels and the annotation data may be generated by two different users. The customer service labels may be generated by a user configured to collect and index the customer service complaints. The annotation data may be generated by inappropriate behavior experts that are trained to detect inappropriate behavior based on audio and/or written reports. The artificial intelligence algorithms used to re-train or update the pre-trained text classification models may use supervised learning techniques. By having multiple viewers reviewing inappropriate behavior complaints and labelling and/or annotating the customer service complain reports, the performance of the supervised learning techniques can be improved.

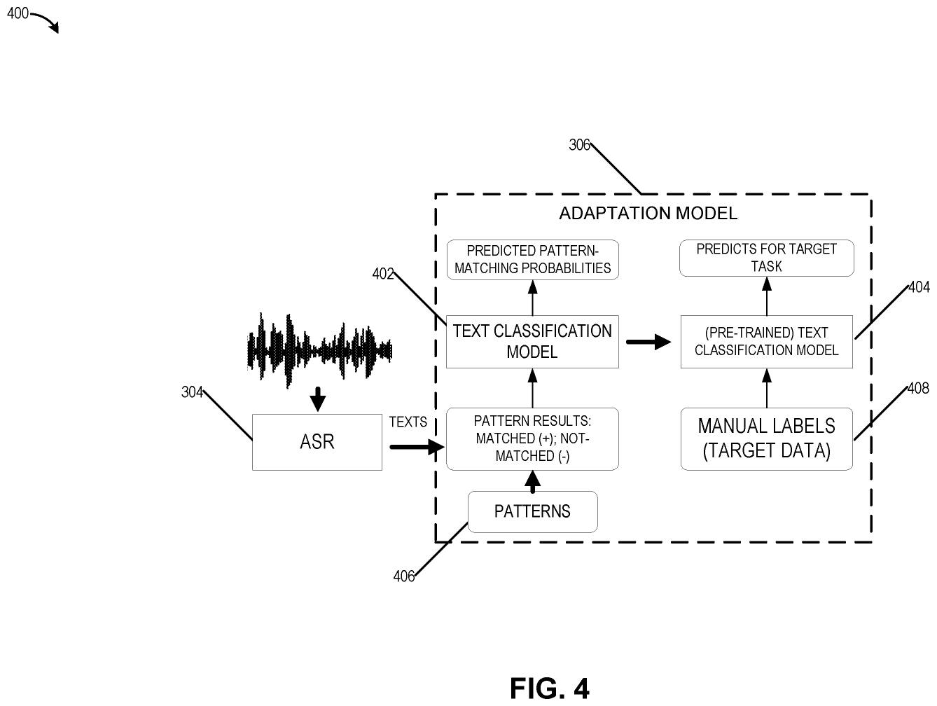

The one or more safety detection models 328 may be used as the trained text classification model used by the adaptation model 306 to predict whether an audio segment received from the audio capture service 204 of the user device 102 indicates inappropriate behavior or other such requests for a user's contact information detectable by user utterances or sound. The model generation system 208 can store the trained safety detection model(s) 328 (e.g., the trained text classification model(s)) in a data store, such as the data store 150. One non-limiting example of the adaptation model 306 that can run and/or generate the trained text classification model is illustrated in FIG. 4.

As previously described, the captured audio 316 may be obtained by an audio capture service 204 on a user device 102. This user device 102 may be a passenger's device or a driver's device. Regardless of whose device, the driver and the user that ordered the ride may be associated with each other based on a shared identifier that may be generated for a ride-sharing event by a ride-sharing application 202. Alternatively, each user may have separate identifiers which may be associated with each other for a ride-sharing event based on the passenger's request for a ride and the driver being assigned or accepting the ride. When a connection is made between the user requesting the ride and the user providing the ride within the ride-sharing application 202, identifiers associated with the driver and passenger may be associated with each other, at least for the ride-sharing event. Thus, if inappropriate behavior occurs, it is possible to identify the driver and user that requested the ride who were involved in the inappropriate behavior.

In some cases, the perpetrator of the inappropriate behavior or the victim may be neither the driver nor the user that requested the ride via the ride-sharing application 202. However, by identifying the driver and the ride-requesting user, it may be possible to assist the victim or identify the perpetrator of the inappropriate behavior through an intervention action (e.g., notifying authorities or providing a location of the vehicle 120 containing the victim or perpetrator to authorities during the ride-sharing event).

### Example Adaptation Model

FIG. 4 illustrates a block diagram of the adaptation model 306 of FIG. 3 in accordance with certain aspects of the present disclosure. While FIG. 4 depicts the adaptation model 306 as pre-training a text classification model 402 and training the pre-trained text classification model 404, this is not meant to be limiting. For example, the model generation system 208 can perform some or all of the pre-training operations and/or the training operations separately or in conjunction with the adaptation model 306.

As illustrated in FIG. 4, the adaptation model 306 can obtain one or more patterns 406 and text generated by the ASR system 304. The pattern(s) 406 can be generated by the adaptation model 306, the model generation system 208, manually by a user, or by a third party system (not shown). The pattern(s) 406 may each include one or more rules that, if satisfied (or not satisfied), indicate that inappropriate behavior has possibly occurred. The text can be generated by the ASR system 304 based on historical audio segments captured by one or more audio capture services 204 during previous ride-share events, based on audio segments generated by an administrator, based on audio segments obtained from a third party source, and/or the like. The text can include various text portions corresponding to a single audio segment.

The adaptation model 306 can run the pattern(s) 406 on the text to determine whether any text portions match a pattern (e.g., satisfy or do not satisfy some or all of the rule(s) of the pattern). If a text portion matches a pattern, the adaptation model 306 can label the text portion as matching a pattern (e.g., label the text portion with the “+” symbol). If a text portion does not match a pattern, the adaptation model 306 can label the text portion as not matching a pattern (e.g., label the text portion with the “−” symbol).

The adaptation model 306 can then pre-train a text classification model 402 using the labeled text portions as the training data and using one or more artificial intelligence algorithms. The pre-trained text classification model 402, when provided with text corresponding to audio segments as an input, can output a predicted probability that the inputted text matches a pattern, and therefore a predicted probability that the inputted text corresponds to the occurrence of inappropriate behavior.

Before, during, and/or after pre-training the text classification model 402, the adaptation model 306 can obtain manual labels 408. The manual labels 408 may be text portions or other types of data instances that are manually labeled (e.g., by a domain expert or annotator who may manually listen to the audio) to indicate instances of inappropriate behavior, instances of appropriate behavior, and/or any instances that may be considered a gray area between inappropriate and appropriate behavior. In some cases, the text portions or other types of data instances that are manually labeled as corresponding to instances of inappropriate behavior also match at least one of the patterns 406.

The adaptation model 306 can train the pre-trained text classification model 402 using the manual labels 408 to form a trained text classification model 404. For example, the adaptation model 306 can re-train or update the pre-trained text classification model 402 using the manual labels 408 to form the trained text classification model 404. The trained text classification model 404, when provided with text corresponding to audio segments as an input, can output a final predicted probability or likelihood that the inputted text corresponds to an occurrence of inappropriate behavior. Because the trained text classification model 404 is trained using a combination of the manual labels 408 and the pattern-based labeled text rather than just one of the two, the trained text classification model 404 may produce more accurate results than the pre-trained text classification model 402.

Accordingly, when the inappropriate behavior detection system 206 is run in real-time or near real-time to detect a possible instance of inappropriate behavior during a current or recently concluded ride-share event, the ASR system 304 can provide text converted from audio segments captured by the audio capture service 204 of the user device 102 associated with the ride-share event (e.g., present during the ride-share event) to the adaptation model 306, and the adaptation model 306 can apply the text as an input to the trained text classification model 404. The trained text classification model 404 may output a predicted likelihood that the text corresponds to an occurrence of inappropriate probability, and the adaptation model 306 can provide the outputted predicted likelihood to the block 308 for evaluation.

### Experimental Results

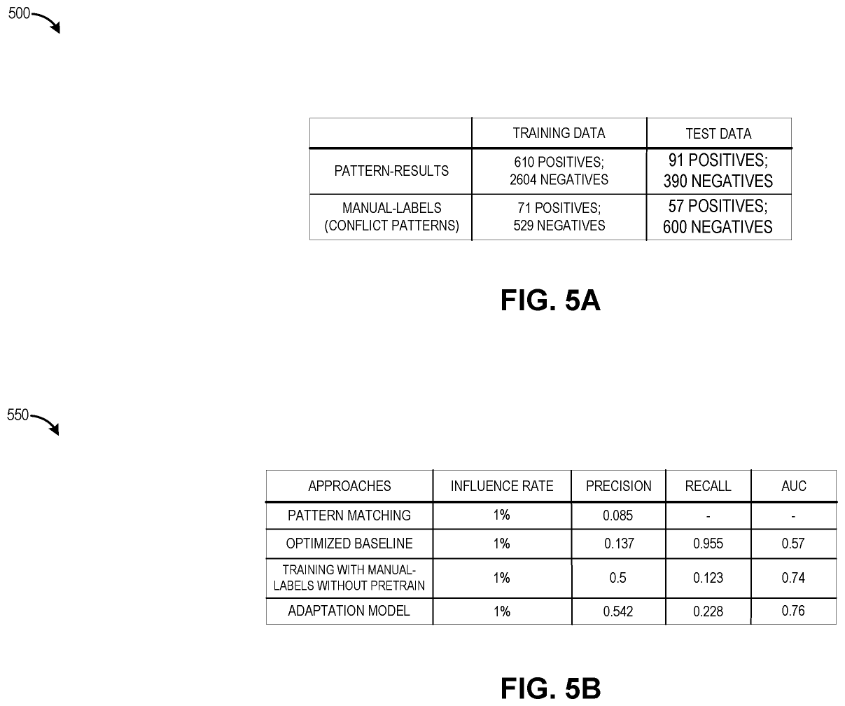

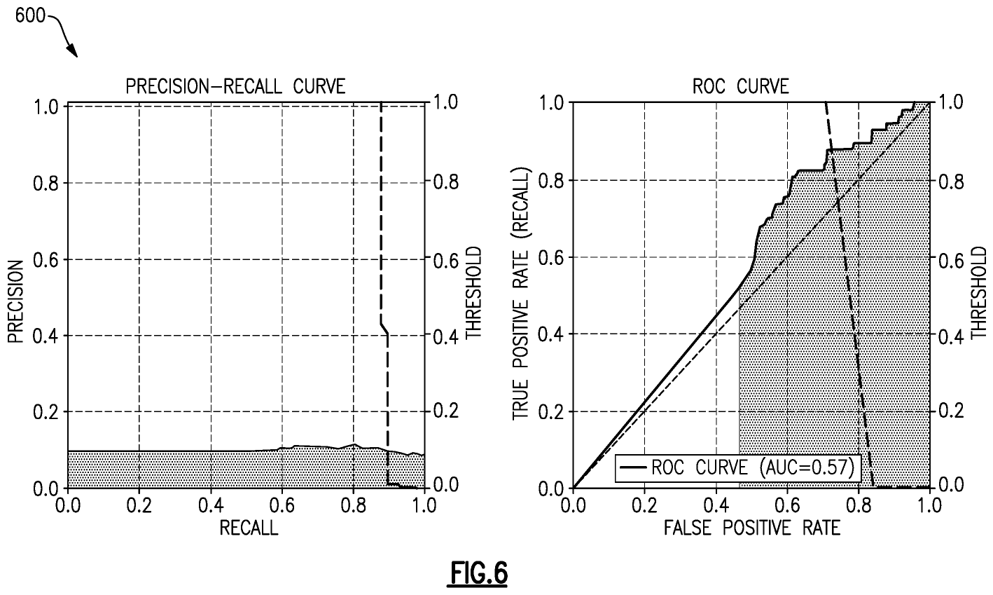

FIG. 5A presents a table 500 of sample datasets applied to an embodiment of the safety incidence detection system 300. For example, the table 500 gives the training and test data used during an experiment in which the performance of the safety incidence detection system 300 was compared to other systems. In particular, the training data includes 610 text portions identified as matching a pattern (e.g., a pattern used to detect possible incidences of inappropriate behavior, where the data points are positive data points), 2604 text portions identified as not matching any pattern (e.g., negative data points), 71 text portions manually labeled as corresponding to incidences of inappropriate behavior (e.g., positive data points), and 529 text portions manually labeled as corresponding to incidences of appropriate behavior (e.g., negative data points). In some cases, the text portions in the training data that do or do not match a pattern are determined based on applying one or more patterns to text portions generated by the ASR system 304. In some instances, the text portions manually labeled as corresponding to incidences of inappropriate behavior also match at least one pattern.

The test data includes 91 text portions identified as matching a pattern (e.g., a pattern used to detect possible incidences of inappropriate behavior), 390 text portions identified as not matching any pattern, 57 text portions manually labeled as corresponding to incidences of inappropriate behavior, and 600 text portions manually labeled as corresponding to incidences of appropriate behavior. The manually labeled text portions are the target test dataset on which the performance of the various systems was evaluated.

FIG. 5B presents a table 550 of example performance results as a result of an application of an embodiment of the safety incidence detection system 300 and embodiments of other systems. As illustrated in FIG. 5B, the table 550 identifies four approaches: pattern matching, optimized baseline, training with manual labels without performing a pre-training operation, and adaptation model, where the adaptation model approach represents an implementation of the safety incidence detection system 300 described herein.

The pattern matching approach is a typical approach that applies patterns to a dataset randomly selected from all the data in one time period (e.g., a day). In the pattern matching approach, each pattern-matched segment is manually labeled to see whether the respective pattern-matched segment is actually a positive segment (e.g., inappropriate behavior in which there is intent to ask for contact information). In the experiment, 30 patterns are used, and 1000 out of 100,000 segments randomly selected from all the orders in a time period of one day are identified as matching a pattern. Among the 1000 segments, only 85 segments actually correspond to incidences of inappropriate behavior after manually labelling or a manual inspection. Therefore, the influence rate (defined as the percentage of the whole dataset that is identified as matching a pattern) of the 30 patterns is 1% (e.g., 1000 divided by 100,000), and the precision is 0.085 (e.g., 85 divided by 1000).

The optimized baseline is an approach that trains a model with the pattern-results and inferences the target test data directly. As expected, at the same influence rate, this approach can increase the precision a little compared with the pattern matching approach, but the precision is still low and the overall performance area under the curve (AUC) (e.g., a typical metric that measures the overall performance of a model within the range 0.5-1.0, where the higher the metric the better) is only 0.57, which is a little better than randomly guessing. The optimized baseline approach results in a high recall because all the target test data match the patterns, which indicates that the model has learned the patterns well, but not well enough because (1) patterns are noisy and do not necessarily capture the features of ground-truths well, and (2) the model does not learn from the ground-truths.

As for the training with manual labels without pre-training approach, training a model using this approach can improve the performance because manual labels are ground truths. For example, the influence rate is 1%, the precision can increase from 0.137 to 0.5, and the AUC can increase from 0.57 to 0.74. However, the number of manual labels is pretty small and this approach may not make use of the patterns that are noisy, but that could create a large training dataset.

The adaptation model approach, however, can increase the precision from 0.5 to 0.542, can increase the recall from 0.123 to 0.228, and can increase the AUC from 0.74 to 0.76, at the same influence rate of 1%, which demonstrates that the adaptation model 306 and the safety incidence detection system 300 described herein is superior to and more accurate than other baseline approaches or methods, thereby resulting in an improvement in computing technology.

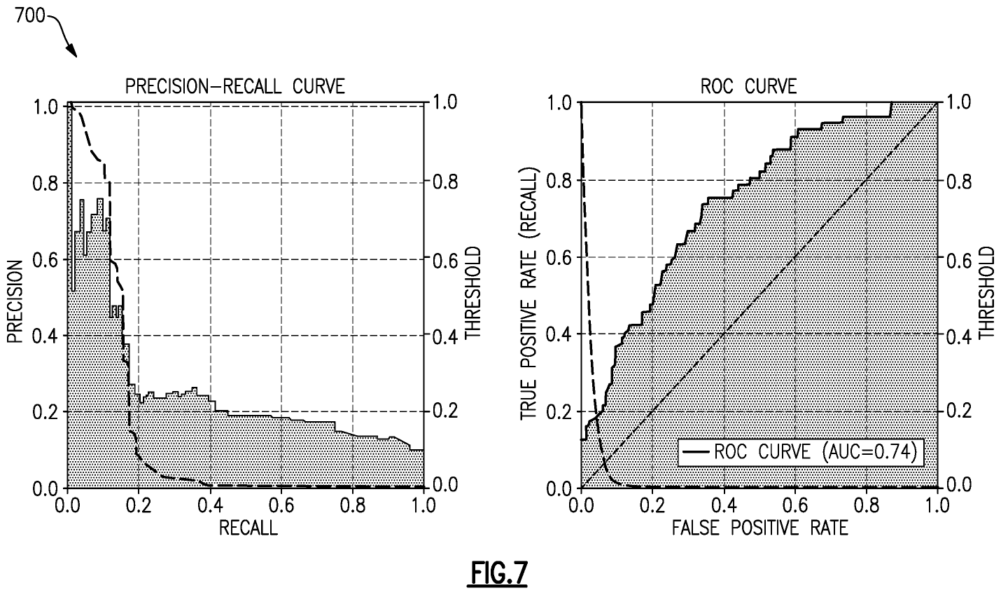

FIGS. 6 and 7 illustrate a set of graphs 600 and 700 illustrating experimental results achieved as a result of an application of embodiments of other systems. For example, FIG. 6 illustrates the graph 600, which depicts the performance results of using the optimized baseline approach. In addition, FIG. 7 illustrates the graph 700, which depicts the performance results of using the training on manual labels without pre-training approach.

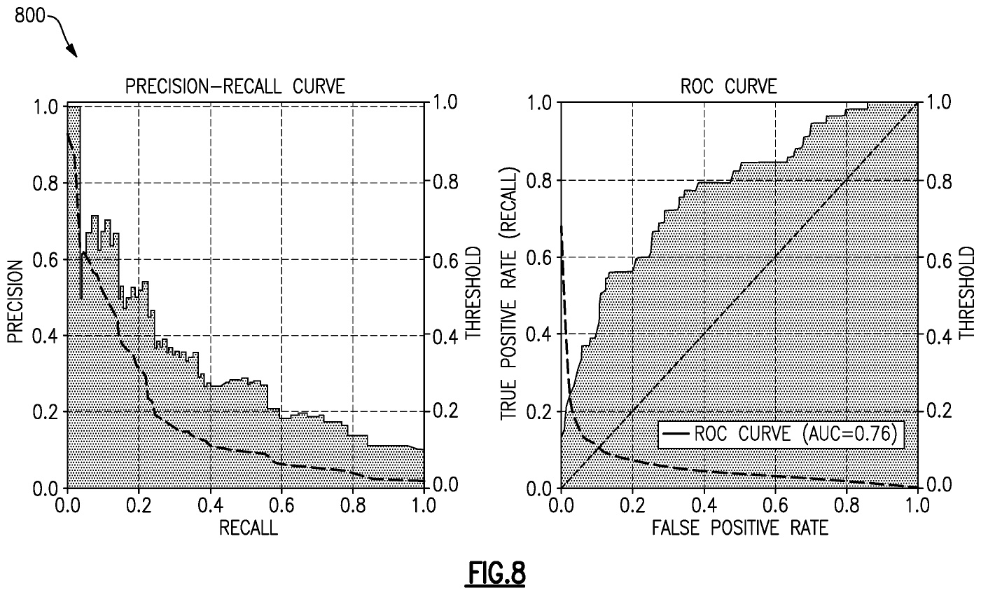

FIG. 8 illustrates a graph 800 illustrating experimental results achieved as a result of an application of an embodiment of the safety incidence detection system 300. For example, the graph 800 depicts the performance results of pre-training a text classification model using pattern-matched text and training the pre-trained text classification model using manual labels.

In regard to the figures described herein, other embodiments are possible, such that the above-recited components, steps, blocks, operations, and/or messages/requests/queries/instructions are differently arranged, sequenced, sub-divided, organized, and/or combined. In some embodiments, a different component may initiate or execute a given operation. For example, the adaptation model 306 can perform some or all of the functionality of the ASR system 304. As another example, the adaptation model 306 can be implemented within a natural language processing system.

### Example Routine for Detecting a Request for Contact Information in a Vehicle

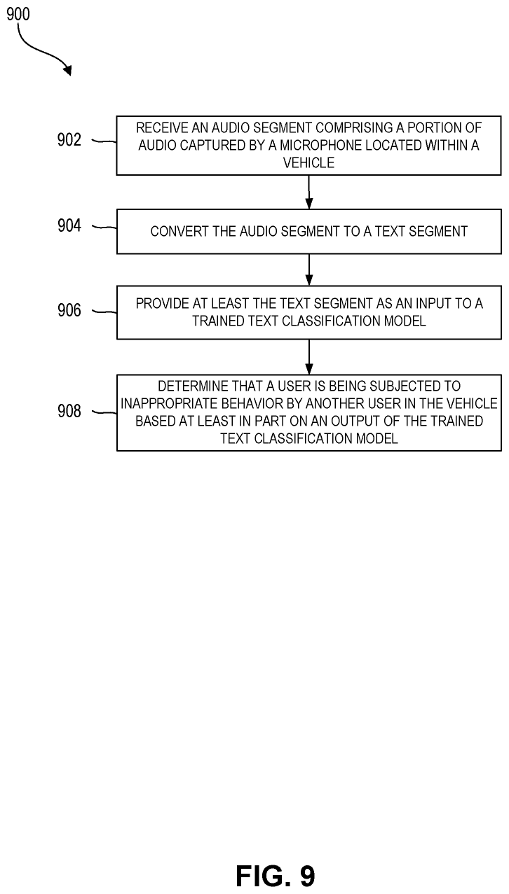

FIG. 9 shows a flow diagram illustrative of embodiments of a routine 900 implemented by the server 130 to detect a request for contact information by a passenger or driver in a vehicle. The elements outlined for routine 900 may be implemented by one or more components of the server 130, such as the inappropriate behavior detection system 206. Alternatively or in addition, the elements outlined for routine 900 may be implemented by one or more components of the server 130 (e.g., the inappropriate behavior detection system 206) and/or a user device 102 (e.g., a ride-sharing application 202, an audio capture service 204, etc.).

At block 902, an audio segment comprising a portion of audio captured by a microphone located within a vehicle is received. For example, the microphone that captures the audio may be the microphone of a user device operated by a passenger or the microphone of a user device operated by a driver in the vehicle. As another example, the microphone that captures the audio may be embedded within the vehicle itself.

At block 904, the audio segment is converted to a text segment. For example, automatic speech recognition may be performed on the audio segment to produce the text segment.

At block 906, at least the text segment is provided as an input to a trained text classification model. For example, the text classification model may be trained to predict when inappropriate behavior may be occurring. Such inappropriate behavior can include one user in the vehicle asking the other user in the vehicle for contact information.

At block 908, a determination is made that a user is being subjected to inappropriate behavior by another user in the vehicle based at least in part on an output of the trained text classification model. For example, the trained text classification model may output a value associated with a likelihood or probability that the text segment includes one or more utterances indicative of inappropriate behavior. Optionally, a countermeasure may be initiated in response to determining that the user is being subjected to inappropriate behavior, such as contacting authorities and/or disabling an account of the violating party. After the determination is made, the routine 900 ends.

Fewer, more, or different blocks can be used as part of the routine 900. In some cases, one or more blocks can be omitted. Furthermore, it will be understood that the various blocks described herein with reference to FIG. 9 can be implemented in a variety of orders, or can be performed concurrently.

### Example Embodiments

Some example enumerated embodiments are recited in this section in the form of methods, systems, and non-transitory computer-readable media, without limitation.

One aspect of the disclosure provides a computer-implemented method as generally shown and described herein and equivalents thereof.

Another aspect of the disclosure provides a system as generally shown and described herein and equivalents thereof.

Another aspect of the disclosure provides a non-transitory computer readable medium storing instructions, which when executed by at least one computing device, perform a method as generally shown and described herein and equivalents thereof.

Another aspect of the disclosure provides a computer-implemented method for detecting a request for contact information in a vehicle. The computer-implemented method comprises: as implemented by an interactive computing system comprising one or more hardware processors and configured with specific computer-executable instructions, receiving an audio segment comprising a portion of audio captured by a microphone located within the vehicle; converting the audio segment to a text segment; providing at least the text segment to a trained text classification model to obtain an inappropriate behavior prediction; and determining that a user is being subjected to inappropriate behavior by another user in the vehicle based at least in part on the inappropriate behavior prediction.

The computer-implemented method of the preceding paragraph can include any sub-combination of the following features: where the computer-implemented method further comprises providing the audio segment to an emotion detector to obtain a detected emotion of a speaking user that made an utterance included in the audio segment, and determining based at least in part on the inappropriate behavior prediction and the detected emotion that a user is being subjected to inappropriate behavior by the another user; where the inappropriate behavior comprises a request for contact information of the user; and where the trained text classification model comprises one of a trained hierarchical attention network (HAN) or a trained convolutional neural network (CNN) model.

Another aspect of the disclosure provides a computer-implemented method for training a model to detect a request for contact information. The computer-implemented method comprises: as implemented by an interactive computing system comprising one or more hardware processors and configured with specific computer-executable instructions, receiving an audio segment comprising a portion of audio associated with a ride-share event; converting the audio segment to a text segment; obtaining one or more patterns associated with inappropriate behavior detection; determining that the text segment matches at least one of the one or more patterns; labeling the text segment as corresponding to inappropriate behavior; pre-training a text classification model using at least in part the labeled text segment; obtaining manually labeled data associated with inappropriate behavior detection; and training the pre-trained text classification model using at least in part the manually labeled data.

Another aspect of the disclosure provides a computer-implemented method for detecting a request for contact information in a vehicle. The computer-implemented method comprises: receiving an audio segment comprising a portion of audio captured by a microphone located within the vehicle; converting the audio segment to a text segment; providing at least the text segment to a trained text classification model to obtain an inappropriate behavior prediction; and determining that a user is being subjected to inappropriate behavior by another user in the vehicle based at least in part on the inappropriate behavior prediction.

The computer-implemented method of the preceding paragraph can include any sub-combination of the following features: where the computer-implemented method further comprises providing the audio segment to an emotion detector to obtain a detected emotion of a speaking user that made an utterance included in the audio segment, and determining based at least in part on the inappropriate behavior prediction and the detected emotion that a user is being subjected to inappropriate behavior by the another user; where the inappropriate behavior comprises a request for contact information of the user; where the trained text classification model comprises one of a trained hierarchical attention network (HAN) or a trained convolutional neural network (CNN) model; where the computer-implemented method further comprises: receiving a second audio segment comprising a portion of second audio associated with a ride-share event, converting the second audio segment to a second text segment, obtaining one or more patterns associated with inappropriate behavior detection, determining that the second text segment matches at least one of the one or more patterns, labeling the second text segment as corresponding to inappropriate behavior, pre-training a text classification model using at least in part the labeled second text segment, obtaining manually labeled data associated with inappropriate behavior detection, and training the pre-trained text classification model using at least in part the manually labeled data to form the trained text classification model; where the one or more patterns each comprise one or more rules that, if satisfied, indicate that inappropriate behavior has occurred; where the computer-implemented method further comprises filtering noise from the audio segment prior to converting the audio segment to the text segment; where filtering noise from the audio segment further comprises filtering, from the audio segment, at least one of a non-utterance, audio related to a navigation system, or audio uttered by a user other than a user present inside the vehicle; where filtering noise from the audio segment further comprises filtering, from the audio segment, audio associated with spoken directions based on a known output from a navigation application; where the computer-implemented method further comprises causing a countermeasure to be initiated in response to the determination that the user is being subjected to the inappropriate behavior by the another user; where a user device operated by a passenger in the vehicle comprises the microphone; and where a user device operated by a driver of the vehicle comprises the microphone.

Another aspect of the disclosure provides a system comprising a data store comprising a trained text classification model. The system further comprises a processor in communication with the data store, the processor configured with computer-executable instructions that, when executed, cause the processor to: obtain an audio segment comprising a portion of audio captured by a microphone located within a vehicle; convert the audio segment to a text segment from the data store; retrieve the trained text classification mode; provide at least the text segment to the trained text classification model to obtain an inappropriate behavior prediction; and determine that a user is being subjected to inappropriate behavior by another user in the vehicle based at least in part on the inappropriate behavior prediction.

The system of the preceding paragraph can include any sub-combination of the following features: where the computer-executable instructions, when executed, further cause the processor to: provide the audio segment to an emotion detector to obtain a detected emotion of a speaking user that made an utterance included in the audio segment, and determine based at least in part on the inappropriate behavior prediction and the detected emotion that a user is being subjected to inappropriate behavior by the another user; where the inappropriate behavior comprises a request for contact information of the user; where the trained text classification model comprises one of a trained hierarchical attention network (HAN) or a trained convolutional neural network (CNN) model; and where the computer-executable instructions, when executed, further cause the processor to: obtain a second audio segment comprising a portion of second audio associated with a ride-share event, convert the second audio segment to a second text segment, obtain one or more patterns associated with inappropriate behavior detection, determine that the second text segment matches at least one of the one or more patterns, label the second text segment as corresponding to inappropriate behavior, pre-train a text classification model using at least in part the labeled second text segment, obtain manually labeled data associated with inappropriate behavior detection, and train the pre-trained text classification model using at least in part the manually labeled data to form the trained text classification model.

Another aspect of the disclosure provides non-transitory, computer-readable storage media comprising computer executable instructions for detecting a request for contact information in a vehicle, where the computer-executable instructions, when executed by a computing system, cause the computing system to: obtain an audio segment comprising a portion of audio captured by a microphone located within the vehicle; convert the audio segment to a text segment from the data store; provide at least the text segment to a trained text classification model to obtain an inappropriate behavior prediction; and determine that a user is being subjected to inappropriate behavior by another user in the vehicle based at least in part on the inappropriate behavior prediction.

The non-transitory, computer-readable storage media of the preceding paragraph can include any sub-combination of the following features: where the computer-executable instructions, when executed, further cause the computing system to: provide the audio segment to an emotion detector to obtain a detected emotion of a speaking user that made an utterance included in the audio segment, and determine based at least in part on the inappropriate behavior prediction and the detected emotion that a user is being subjected to inappropriate behavior by the another user; and where the computer-executable instructions, when executed, further cause the computing system to: obtain a second audio segment comprising a portion of second audio associated with a ride-share event, convert the second audio segment to a second text segment, obtain one or more patterns associated with inappropriate behavior detection, determine that the second text segment matches at least one of the one or more patterns, label the second text segment as corresponding to inappropriate behavior, pre-train a text classification model using at least in part the labeled second text segment, obtain manually labeled data associated with inappropriate behavior detection, and train the pre-trained text classification model using at least in part the manually labeled data to form the trained text classification model.

In other embodiments, a system or systems may operate according to one or more of the methods and/or computer-readable media recited in the preceding paragraphs. In yet other embodiments, a method or methods may operate according to one or more of the systems and/or computer-readable media recited in the preceding paragraphs. In yet more embodiments, a computer-readable medium or media, excluding transitory propagating signals, may cause one or more computing devices having one or more processors and non-transitory computer-readable memory to operate according to one or more of the systems and/or methods recited in the preceding paragraphs.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of one or more embodiments can be modified, if necessary, to employ the systems, functions, and concepts of the various references described above. These and other changes can be made in light of the above Detailed Description. While the above description describes certain examples, and describes the best mode contemplated, no matter how detailed the above appears in text, different embodiments can be practiced in many ways. Details of the system may vary considerably in its specific implementation. As noted above, particular terminology used when describing certain features should not be taken to imply that the terminology is being redefined herein to be restricted to any specific characteristics, features with which that terminology is associated. In general, the terms used in the following claims should not be construed to limit the scope the specific examples disclosed in the specification, unless the above Detailed Description section explicitly defines such terms. Accordingly, the actual scope encompasses not only the disclosed examples, but also all equivalent ways of practicing or implementing the claims.

To reduce the number of claims, certain aspects of the present disclosure are presented below in certain claim forms, but the applicant contemplates other aspects of the present disclosure in any number of claim forms. For example, while only one aspect of the present disclosure is recited as a means-plus-function claim under 35 U.S.C sec. 112(f) (AIA), other aspects may likewise be embodied as a means-plus-function claim, or in other forms, such as being embodied in a computer-readable medium. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

What is claimed is:

1. A computer-implemented method for detecting a request for contact information in a vehicle, the computer-implemented method comprising:
receiving an audio segment comprising a portion of audio captured by a microphone located within the vehicle;
converting the audio segment to a text segment;
providing at least the text segment to a trained text classification model to obtain an inappropriate behavior prediction; and
determining that a user is being subjected to inappropriate behavior by another user in the vehicle based at least in part on the inappropriate behavior prediction.

2. The computer-implemented method of claim 1, further comprising:
providing the audio segment to an emotion detector to obtain a detected emotion of a speaking user that made an utterance included in the audio segment; and
determining based at least in part on the inappropriate behavior prediction and the detected emotion that a user is being subjected to inappropriate behavior by the another user.

3. The computer-implemented method of claim 1, wherein the inappropriate behavior comprises a request for contact information of the user.

4. The computer-implemented method of claim 1, wherein the trained text classification model comprises one of a trained hierarchical attention network (HAN) or a trained convolutional neural network (CNN) model.

5. The computer-implemented method of claim 1, further comprising:
receiving a second audio segment comprising a portion of second audio associated with a ride-share event;
converting the second audio segment to a second text segment;
obtaining one or more patterns associated with inappropriate behavior detection;
determining that the second text segment matches at least one of the one or more patterns;
labeling the second text segment as corresponding to inappropriate behavior;
pre-training a text classification model using at least in part the labeled second text segment;
obtaining manually labeled data associated with inappropriate behavior detection; and
training the pre-trained text classification model using at least in part the manually labeled data to form the trained text classification model.

6. The computer-implemented method of claim 5, wherein the one or more patterns each comprise one or more rules that, if satisfied, indicate that inappropriate behavior has occurred.

7. The computer-implemented method of claim 1, further comprising filtering noise from the audio segment prior to converting the audio segment to the text segment.

8. The computer-implemented method of claim 7, wherein filtering noise from the audio segment further comprises filtering, from the audio segment, at least one of a non-utterance, audio related to a navigation system, or audio uttered by a user other than a user present inside the vehicle.

9. The computer-implemented method of claim 7, wherein filtering noise from the audio segment further comprises filtering, from the audio segment, audio associated with spoken directions based on a known output from a navigation application.

10. The computer-implemented method of claim 1, further comprising causing a countermeasure to be initiated in response to the determination that the user is being subjected to the inappropriate behavior by the another user.

11. The computer-implemented method of claim 1, wherein a user device operated by a passenger in the vehicle comprises the microphone.

12. The computer-implemented method of claim 1, wherein a user device operated by a driver of the vehicle comprises the microphone.

13. A system comprising:
a data store comprising a trained text classification model; and
a processor in communication with the data store, the processor configured with computer-executable instructions that, when executed, cause the processor to:
obtain an audio segment comprising a portion of audio captured by a microphone located within a vehicle;
convert the audio segment to a text segment from the data store;
retrieve the trained text classification mode;
provide at least the text segment to the trained text classification model to obtain an inappropriate behavior prediction; and
determine that a user is being subjected to inappropriate behavior by another user in the vehicle based at least in part on the inappropriate behavior prediction.

14. The system of claim 13, wherein the computer-executable instructions, when executed, further cause the processor to:
provide the audio segment to an emotion detector to obtain a detected emotion of a speaking user that made an utterance included in the audio segment; and
determine based at least in part on the inappropriate behavior prediction and the detected emotion that a user is being subjected to inappropriate behavior by the another user.

15. The system of claim 13, wherein the inappropriate behavior comprises a request for contact information of the user.

16. The system of claim 13, wherein the trained text classification model comprises one of a trained hierarchical attention network (HAN) or a trained convolutional neural network (CNN) model.

17. The system of claim 13, wherein the computer-executable instructions, when executed, further cause the processor to:
obtain a second audio segment comprising a portion of second audio associated with a ride-share event;
convert the second audio segment to a second text segment;
obtain one or more patterns associated with inappropriate behavior detection;
determine that the second text segment matches at least one of the one or more patterns;
label the second text segment as corresponding to inappropriate behavior;
pre-train a text classification model using at least in part the labeled second text segment;
obtain manually labeled data associated with inappropriate behavior detection; and
train the pre-trained text classification model using at least in part the manually labeled data to form the trained text classification model.

18. Non-transitory, computer-readable storage media comprising computer executable instructions for detecting a request for contact information in a vehicle, wherein the computer-executable instructions, when executed by a computing system, cause the computing system to:
obtain an audio segment comprising a portion of audio captured by a microphone located within the vehicle;
convert the audio segment to a text segment from the data store;
provide at least the text segment to a trained text classification model to obtain an inappropriate behavior prediction; and
determine that a user is being subjected to inappropriate behavior by another user in the vehicle based at least in part on the inappropriate behavior prediction.

19. The non-transitory, computer-readable storage media of claim 18, wherein the computer-executable instructions, when executed, further cause the computing system to:
provide the audio segment to an emotion detector to obtain a detected emotion of a speaking user that made an utterance included in the audio segment; and
determine based at least in part on the inappropriate behavior prediction and the detected emotion that a user is being subjected to inappropriate behavior by the another user.

20. The non-transitory, computer-readable storage media of claim 18, wherein the computer-executable instructions, when executed, further cause the computing system to:
obtain a second audio segment comprising a portion of second audio associated with a ride-share event;
convert the second audio segment to a second text segment;
obtain one or more patterns associated with inappropriate behavior detection;
determine that the second text segment matches at least one of the one or more patterns;
label the second text segment as corresponding to inappropriate behavior;
pre-train a text classification model using at least in part the labeled second text segment;
obtain manually labeled data associated with inappropriate behavior detection; and
train the pre-trained text classification model using at least in part the manually labeled data to form the trained text classification model.
